(19) United States
(12) Patent Application Publication
(10) Pub. No.: US 2024/0147284 A1
(43) Pub. Date: May 2, 2024

(54) PREDICTION BASED BEAM MANAGEMENT IN CELLULAR SYSTEMS

(71) Applicant: Samsung Electronics Co., Ltd., Suwon-si (KR)

(72) Inventor: Jeongho Jeon, San Jose, CA (US)

(21) Appl. No.: 18/482,817

(22) Filed: Oct. 6, 2023

Related U.S. Application Data
(60) Provisional application No. 63/419,486, filed on Oct. 26, 2022.

(51) Int. Cl. H04W 24/10; H04L 5/00

(52) U.S. Cl. CPC H04W 24/10; H04L 5/0048

(57) ABSTRACT

Method and apparatuses for prediction based beam management in cellular systems. A method for a user equipment (UE) to report information related to a beam prediction is provided. The method includes receiving first information related to reception of reference signals (RSs) for beam measurements, second information indicating one or more reporting quantities related to the beam prediction, third information related to determining the one or more reporting quantities, fourth information related to transmitting the one or more reporting quantities, and the RSs for the beam measurements based on the first information. The method further includes measuring the RSs, determining the one or more reporting quantities indicated by the second information based on the third information and the measurement of RSs, and transmitting a channel with the one or more reporting quantities based on the fourth information.

### CROSS-REFERENCE TO RELATED APPLICATION(S) AND CLAIM OF PRIORITY

The present application claims priority under 35 U.S.C. § 119(e) to U.S. Provisional Patent Application No. 63/419,486 filed on Oct. 26, 2022, which is hereby incorporated by reference in its entirety.

### TECHNICAL FIELD

The present disclosure relates generally to wireless communication systems and, more specifically, the present disclosure relates to methods and apparatuses for prediction based beam management in cellular systems.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. To meet the demand for wireless data traffic having increased since deployment of 4G communication systems, and to enable various vertical applications, 5G communication systems have been developed and are currently being deployed.

### SUMMARY

The present disclosure relates to prediction based beam management in cellular systems.

In one embodiment, a method for a user equipment (UE) to report information related to a beam prediction is provided. The method includes receiving first information related to reception of reference signals (RSs) for beam measurements, second information indicating one or more reporting quantities related to the beam prediction, third information related to determining the one or more reporting quantities, fourth information related to transmitting the one or more reporting quantities, and the RSs for the beam measurements based on the first information. The method further includes measuring the RSs, determining the one or more reporting quantities indicated by the second information based on the third information and the measurement of RSs, and transmitting a channel with the one or more reporting quantities based on the fourth information.

In another embodiment, a UE is provided. The UE includes a transceiver configured to receive first information related to reception of RSs for beam measurements, second information indicating one or more reporting quantities related to a beam prediction, third information related to determining the one or more reporting quantities, fourth information related to transmitting the one or more reporting quantities, and the RSs for the beam measurements based on the first information. The UE further includes a processor operably coupled to the transceiver. The processor is configured to measure the RSs and determine the one or more reporting quantities indicated by the second information based on the third information and the measurement of RSs. The transceiver is further configured to transmit a channel with the one or more reporting quantities based on the fourth information.

In yet another embodiment, a base station (BS) is provided. The BS includes a transceiver configured to transmit first information related to reception of RSs for beam measurements, second information indicating one or more reporting quantities related to a beam prediction, third information related to determining the one or more reporting quantities, fourth information related to transmitting the one or more reporting quantities, and the RSs for the beam measurements based on the first information. The transceiver is further configured to receive, based on the fourth information, a channel with the one or more reporting quantities that are based on the third information and the RSs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a diagram of an example beam measurement model according to embodiments of the present disclosure;

FIG. 7 illustrates a diagram of an example beam prediction based on measurements of wide beams according to embodiments of the present disclosure;

FIG. 8 illustrates a diagram of an example beam prediction based on measurements of sparse beams according to embodiments of the present disclosure;

FIG. 9 illustrates a flowchart of an example UE procedure for spatial/temporal domain beam prediction according to embodiments of the present disclosure; and

FIG. 10 illustrates a flowchart of an example UE procedure for sending assistance information to a serving cell for performing beam prediction according to embodiments of the present disclosure.

### DETAILED DESCRIPTION

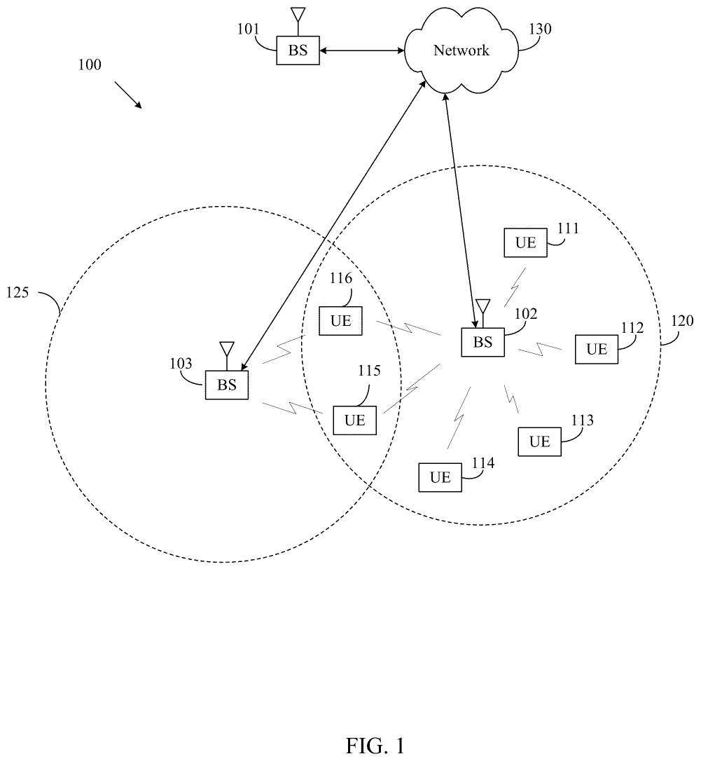

FIGS. 1-10, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band.

For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and Channel coding;” [3] 3GPP TS 38.213 v16.1.0, “NR; Physical Layer Procedures for Control;” [4] 3GPP TS 38.214 v16.1.0, “NR; Physical Layer Procedures for Data;” [5] 3GPP TS 38.215 v17.1.0, “NR; Physical layer measurements;” [6] 3GPP TS 38.331 v17.1.0, “NR; Radio Resource Control (RRC) protocol specification;” [7] 3GPP TS 38.321 v17.1.0, “NR; Medium Access Control (MAC) protocol specification;” [8] 3GPP TS 38.133 v17.6.0, “NR; Requirements for support of radio resource management;” [9] 3GPP TS 38.300 v17.0.0, “NR; NR and NG-RAN Overall Description.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3 rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for prediction based beam management in cellular systems. In certain embodiments, one or more of the BSs 101-103 include circuitry, programing, or a combination thereof to support prediction based beam management in cellular systems.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

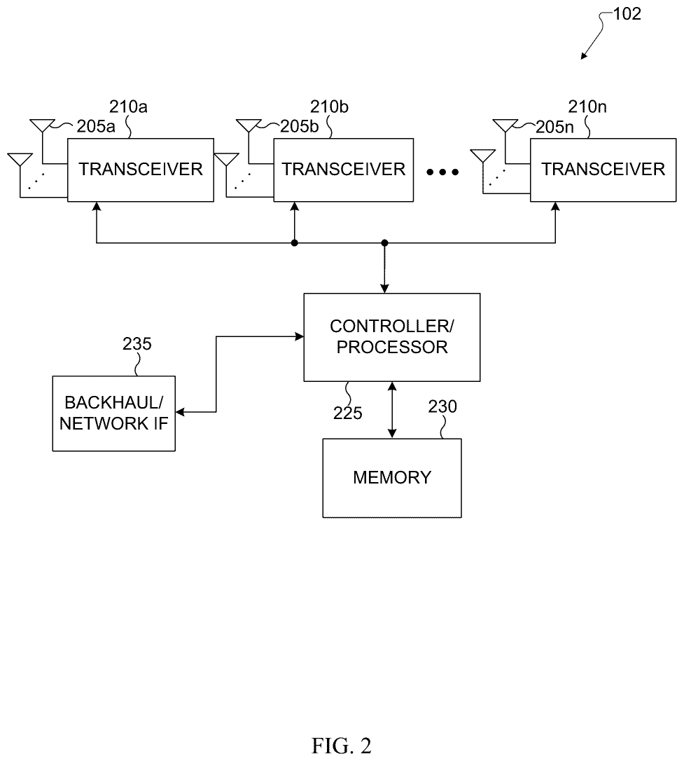

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for prediction based beam management in cellular systems. Any of a wide variety of other functions could be supported in the gNB 102 by the controller/processor 225.

The controller/processor 225 is also capable of executing programs and other processes resident in the memory 230, such as processes to support prediction based beam management in cellular systems as described in various embodiments of the present disclosure. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

In the present disclosure, an italicized name for a parameter implies that the parameter is provided by higher layers. DL transmissions or UL transmissions can be based on an OFDM waveform including a variant using discrete Fourier transform (DFT) precoding that is known as DFT-spread-OFDM that is typically applicable to UL transmissions.

In the present disclosure, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments examine a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

The MIMO technologies have been playing a significant role in boosting system throughput both in NR and LTE and such a role will be continued and further expanded in the future generation wireless technologies.

An antenna port is defined such that the channel over which a symbol on the antenna port is conveyed can be inferred from the channel over which another symbol on the same antenna port is conveyed. There is not necessarily one to one correspondence between an antenna port and an antenna element, and a plurality of antenna elements can be mapped onto one antenna port.

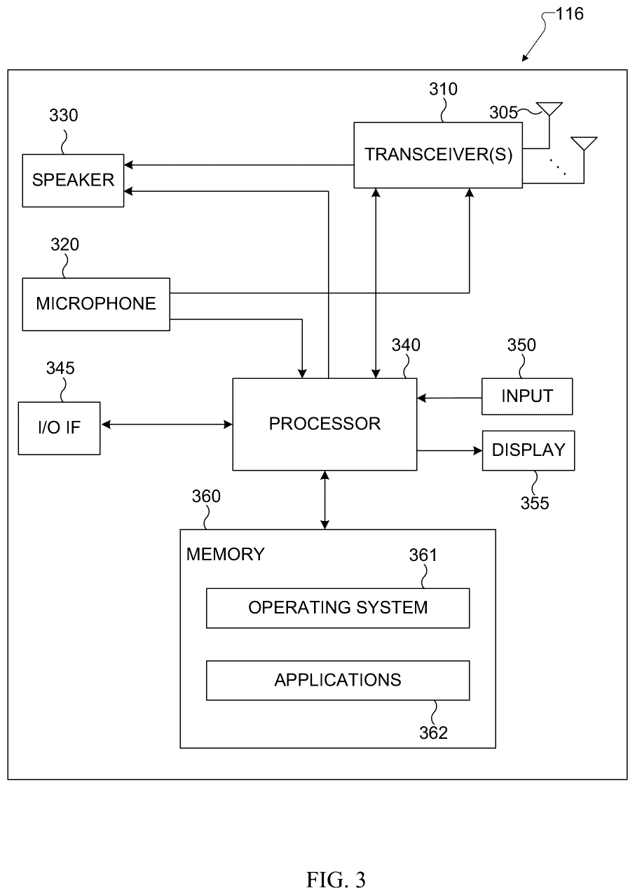

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for prediction based beam management in cellular systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

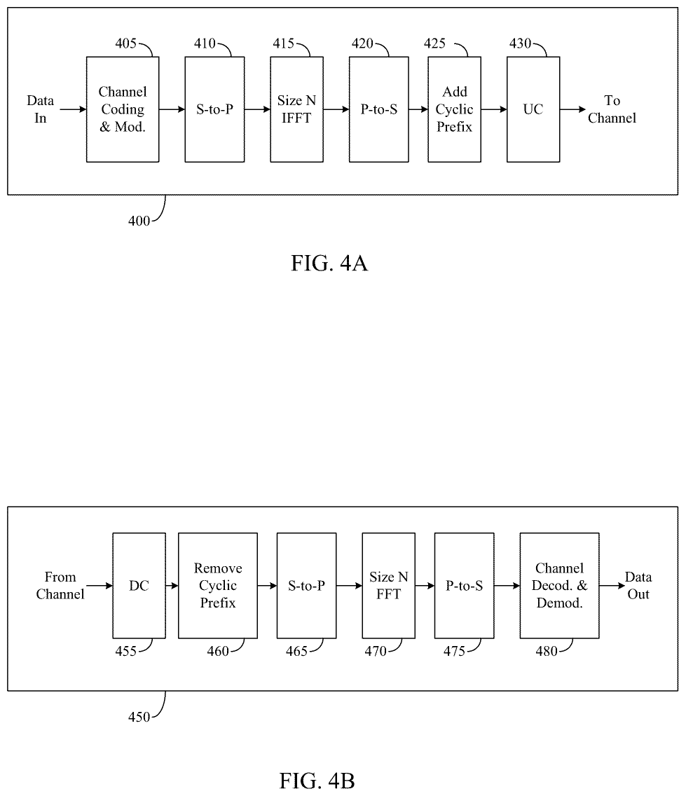

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured to support prediction based beam management in cellular systems as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

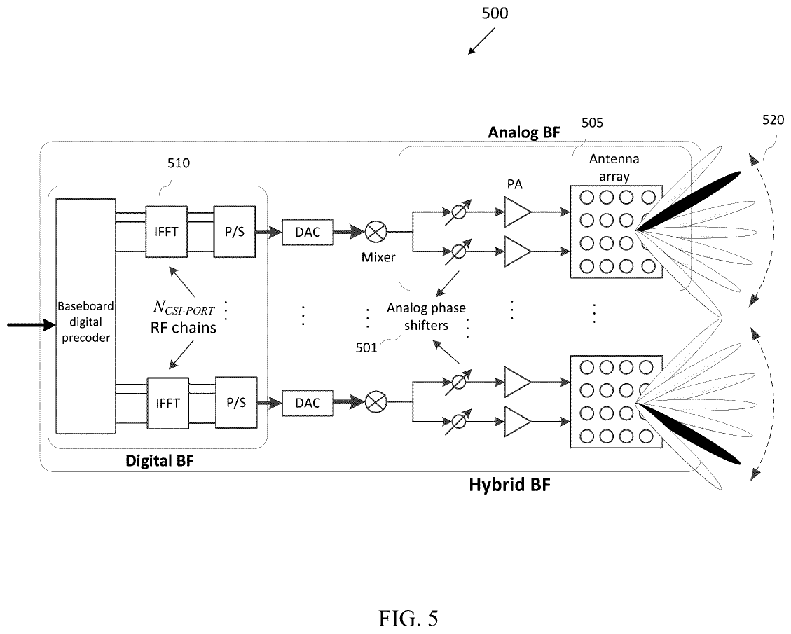

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosure herein that changes in the embodiments and examples shown may be made without departing from the scope of the present disclosure. The transmitter structure 500 for beamforming is for illustration only and other embodiments can be used without departing from the scope of the present disclosure.

To enable digital precoding, efficient design of CSI-RS is a crucial factor. For this reason, three types of CSI reporting mechanism corresponding to three types of CSI-RS measurement behavior are supported in Rel.13 LTE: 1) ‘CLASS A’ CSI reporting which corresponds to non-precoded CSI-RS, 2) ‘CLASS B’ reporting with K=1 CSI-RS resource which corresponds to UE-specific beamformed CSI-RS, 3) ‘CLASS B’ reporting with K>1 CSI-RS resources which corresponds to cell-specific beamformed CSI-RS. For non-precoded (NP) CSI-RS, a cell-specific one-to-one mapping between CSI-RS port and transceiver unit (TXRU) is utilized. Here, different CSI-RS ports have the same wide beam width and direction and hence generally cell-wide coverage. For beamformed CSI-RS, beamforming operation, either cell-specific or UE-specific, is applied on a non-zero-power (NZP) CSI-RS resource (including multiple ports). Here, (at least at a given time/frequency) CSI-RS ports have narrow beam widths and hence not cell-wide coverage, and (at least from the eNB perspective) at least some CSI-RS port-resource combinations have different beam directions. The basic principle remains the same in NR.

In scenarios where DL long-term channel statistics can be measured through UL signals at a serving gNB, UE-specific beamformed CSI-RS can be readily used. This is typically feasible when UL-DL duplex distance is sufficiently small. When this condition does not hold, however, some UE feedback is beneficial for the gNB 102 to obtain an estimate of DL long-term channel statistics (or any of its representation thereof). To facilitate such a procedure, a first beamformed CSI-RS transmitted with periodicity T1 (ms) and a second NP CSI-RS transmitted with periodicity T2 (ms), where T1≤T2. This approach is termed hybrid CSI-RS. The implementation of hybrid CSI-RS is largely dependent on the definition of CSI process and NZP CSI-RS resource.

One of the significant components of a MIMO transmission scheme is the accurate CSI acquisition at gNB 102 (or TRP). For multi-user (MU)-MIMO, in particular, the availability of accurate CSI is warranted in order to guarantee high MU performance. For time division duplexing (TDD) systems, the CSI can be acquired using the sounding reference signal (SRS) transmission relying on the channel reciprocity. For frequency division duplex (FDD) systems, on the other hand, the CSI can be acquired using the CSI-RS transmission from gNB. CSI acquisition and feedback can be acquired from a UE. In LTE up to Rel. 13, for FDD systems, the CSI feedback framework is ‘implicit’ in the form of channel quality information (CQI)/precoding matrix indicator (PMI)/rank indicator (RI) (and CSI-RS indicator (CRI) in Rel. 13) derived from a codebook assuming single user (SU) transmission from eNB. Because of the inherent SU assumption while deriving CSI, this implicit CSI feedback is inadequate for MU transmission. On the other hand, NR systems have been designed to be more MU-centric from its first release with high resolution Type-II codebook in addition to low resolution Type-I codebook.

In RRC CONNECTED, the UE measures multiple beams (at least one) of a cell and the measurements results (power values) are averaged to derive the cell quality. In doing so, the UE is configured to evaluate a subset of the detected beams. Filtering takes place at two distinct levels: at the physical layer to derive beam quality and then at RRC level to derive cell quality from multiple beams. Cell quality from beam measurements is derived in the same way for the serving cell(s) and for the non-serving cell(s). Measurement reports may contain the measurement results of the Xbest beams if the UE is configured to do so by gNB 102.

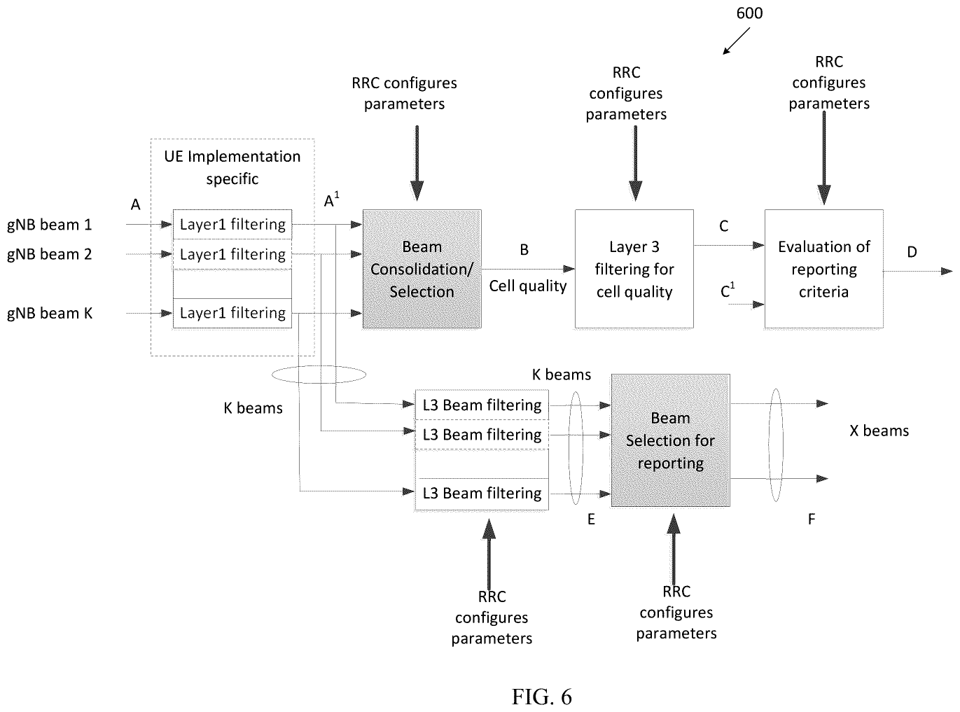

FIG. 6 illustrates a diagram 600 of an example beam measurement model according to embodiments of the present disclosure. For example, diagram 600 of an example beam measurement model can be utilized by any of the UEs 111-116 of FIG. 1. This example is for illustration only and other embodiments can be used without departing from the scope of the present disclosure.

The corresponding high-level measurement model is described herein:
A: measurements (beam specific samples) internal to the physical layer.
Layer 1 filtering: internal layer 1 filtering of the inputs measured at point A. Exact filtering is implementation dependent. How the measurements are actually executed in the physical layer by an implementation (inputs A and Layer 1 filtering) is not constrained by the standard.
A¹: measurements (i.e., beam specific measurements) reported by layer 1 to layer 3 after layer 1 filtering.
Beam Consolidation/Selection: beam specific measurements are consolidated to derive cell quality. The behavior of the Beam consolidation/selection is standardized, and the configuration of this module is provided by RRC signaling. Reporting period at B equals one measurement period at A¹.
B: a measurement (i.e., cell quality) derived from beam-specific measurements reported to layer 3 after beam consolidation/selection.
Layer 3 filtering for cell quality: filtering performed on the measurements provided at point B. The behavior of the Layer 3 filters is standardized, and the configuration of the layer 3 filters is provided by RRC signaling. Filtering reporting period at C equals one measurement period at B.
C: a measurement after processing in the layer 3 filter. The reporting rate is identical to the reporting rate at point B. This measurement is used as input for one or more evaluation of reporting criteria.
Evaluation of reporting criteria: checks whether actual measurement reporting is essential at point D. The evaluation can be based on more than one flow of measurements at reference point C, e.g., to compare between different measurements. This is illustrated by input C and C′. The UE shall evaluate the reporting criteria at least each time a new measurement result is reported at points C and C′. The reporting criteria are standardized, and the configuration is provided by RRC signaling (UE measurements).
D: measurement report information (message) sent on the radio interface.
L3 Beam filtering: filtering performed on the measurements (i.e., beam specific measurements) provided at point A′. The behavior of the beam filters is standardized, and the configuration of the beam filters is provided by RRC signaling. Filtering reporting period at E equals one measurement period at A′.
E: a measurement (i.e., beam-specific measurement) after processing in the beam filter. The reporting rate is identical to the reporting rate at point A′. This measurement is used as input for selecting the X measurements to be reported.
Beam Selection for beam reporting: selects the X measurements from the measurements provided at point E. The behavior of the beam selection is standardized, and the configuration of this module is provided by RRC signaling.
F: beam measurement information included in measurement report (sent) on the radio interface.

Layer 1 filtering introduces a certain level of measurement averaging. How and when the UE exactly performs the essential measurements is implementation specific to the point that the output at B fulfils the performance requirements set in TS 38.133. Layer 3 filtering for cell quality and related parameters used are specified in TS 38.331 and do not introduce any delay in the sample availability between B and C. Measurement at points C and C′ is the input used in the event evaluation. L3 Beam filtering and related parameters used are specified in TS 38.331 and do not introduce any delay in the sample availability between E and F.

Measurement reports are characterized by the following:
Measurement reports include the measurement identity of the associated measurement configuration that triggered the reporting.
Cell and beam measurement quantities to be included in measurement reports are configured by the network 130.
The number of non-serving cells to be reported can be limited through configuration by the network 130.
Cells belonging to an exclude-list configured by the network 130 are not used in event evaluation and reporting, and conversely when an allow-list is configured by the network 130, only the cells belonging to the allow-list are used in event evaluation and reporting.
Beam measurements to be included in measurement reports are configured by the network 130 (beam identifier only, measurement result and beam identifier, or no beam reporting).

Intra-frequency neighbour (cell) measurements and inter-frequency neighbour (cell) measurements are defined as follows:
Synchronization signal/physical broadcast channel (SSB) based intra-frequency measurement: a measurement is defined as an SSB based intra-frequency measurement provided the center frequency of the SSB of the serving cell and the center frequency of the SSB of the neighbor cell are the same, and the subcarrier spacing of the two SSBs is also the same.
SSB based inter-frequency measurement: a measurement is defined as an SSB based inter-frequency measurement provided that the center frequency of the SSB of the serving cell and the center frequency of the SSB of the neighbor cell are different, or the subcarrier spacing of the two SSBs is different.
CSI-RS based intra-frequency measurement: a measurement is defined as a CSI-RS based intra-frequency measurement provided that:
   The subcarrier spacing of CSI-RS resources on the neighbor cell configured for measurement is the same as the SCS of CSI-RS resources on the serving cell indicated for measurement;
   For 60 kHz subcarrier spacing, the CP type of CSI-RS resources on the neighbor cell configured for measurement is the same as the CP type of CSI-RS resources on the serving cell indicated for measurement; and
   The center frequency of CSI-RS resources on the neighbor cell configured for measurement is the same as the center frequency of CSI-RS resource on the serving cell indicated for measurement.
CSI-RS based inter-frequency measurement: a measurement is defined as a CSI-RS based inter-frequency measurement if it is not a CSI-RS based intra-frequency measurement.

Whether a measurement is non-gap-assisted or gap-assisted depends on the capability of the UE, the active bandwidth part (BWP) of the UE, and the current operating frequency.

For SSB based inter-frequency measurement, if the measurement gap requirement information is reported by the UE, a measurement gap configuration may be provided according to the information. Otherwise, a measurement gap configuration is provided in the cases herein:
If the UE only supports per-UE measurement gaps.
If the UE supports per-FR measurement gaps and any of the serving cells are in the same frequency range of the measurement object.

For SSB based intra-frequency measurement, if the measurement gap requirement information is reported by the UE, a measurement gap configuration may be provided according to the information. Otherwise, a measurement gap configuration is provided in the case herein:
Other than the initial BWP, if any of the UE configured BWPs do not contain the frequency domain resources of the SSB associated to the initial DL BWP.

For beam failure detection, gNB 102 configures the UE with beam failure detection reference signals (SSB or CSI-RS) and the UE declares beam failure when the number of beam failure instance indications (BFI) from the physical layer reaches a configured threshold, beamFailurelnstanceMaxCount, before a configured timer expires. For beam failure detection in multi-TRP operation, gNB 102 configures the UE with two sets of beam failure detection reference signals each associated with a TRP. The UE declares beam failure for a TRP when the number of beam failure instance indications associated with the corresponding set of beam failure detection reference signals from the physical layer reaches a configured threshold before a configured timer expires.

SSB-based Beam Failure Detection is based on the SSB associated to the initial DL BWP and can only be configured for the initial DL BWPs and for DL BWPs containing the SSB associated to the initial DL BWP. For other DL BWPs, Beam Failure Detection can only be performed based on CSI-RS.

After beam failure is detected on a PCell, the UE:
triggers beam failure recovery by initiating a Random Access procedure on the PCell.
selects a suitable beam to perform beam failure recovery (if gNB 102 has provided dedicated Random Access resources for certain beams, those will be prioritized by the UE).
includes an indication of a beam failure on PCell in a BFR MAC CE if the Random Access procedure involves contention-based random access.

Upon completion of the Random-Access procedure, beam failure recovery for PCell is regarded as complete.

After beam failure is detected on an SCell, the UE:
triggers beam failure recovery by initiating a transmission of a BFR MAC CE for this SCell.
selects a suitable beam for this SCell (if available) and indicates it along with the information about the beam failure in the BFR MAC CE.

Upon reception of a PDCCH indicating an uplink grant for a new transmission for the hybrid automatic repeat request (HARQ) process used for the transmission of the BFR MAC CE, beam failure recovery for this SCell is regarded as complete.

After beam failure is detected for a TRP of Serving Cell, the UE:
triggers beam failure recovery by initiating a transmission of a BFR MAC CE for this TRP.
selects a suitable beam for this TRP (if available) and indicates whether the suitable (new) beam is found or not, along with the information about the beam failure in the BFR MAC CE for this TRP.

Upon reception of a PDCCH indicating an uplink grant for a new transmission for the HARQ process used for the transmission of the BFR MAC CE for this TRP, beam failure recovery for this TRP is regarded as complete.

After beam failure is detected for both TRPs of PCell, the UE:
triggers beam failure recovery by initiating a Random Access procedure on the PCell.
selects a suitable beam for each failed TRP (if available) and indicates whether the suitable (new) beam is found or not along with the information about the beam failure in the BFR MAC CE for each failed TRP.
upon completion of the Random Access procedure, beam failure recovery for both TRPs of PCell is regarded as complete.

In the present network, the applications and the standardization impact of AWL-based methods have been mostly limited to network layers. There have been standardization efforts related to AI/ML functions in the open radio access network (O-RAN) Alliance and the Third Generation Partnership Project (3GPP). In particular, the O-RAN Alliance is developing a virtualized RAN with open interfaces and network intelligence with entities such as Non-Real-Time (RT) RAN Intelligence Controller (RIC) and near-RT RIC. The Non-RT RIC is a logical function that enables non-real-time control and optimization of RAN elements and resources, which governs the overall AI/ML workflow for an O-RAN network, including model training, inference, and updates. The Near-RT RIC is a logical function that enables near-real-time control and optimization of RAN elements and resources via fine-grained data collection and actions over the RAN interface. On the other hand, the 3GPP has defined Network Data Analytics Function (NWDAF) for network slice management in Rel-15 and it has been further enhanced in Rel-16 and Rel-17. The 3GPP also defined the functional framework for RAN intelligence enabled by data collection.

It is expected that AI/ML methods will be applied for various cellular system air interface designs including CSI compression/recovery, future CSI prediction, learning-based channel estimation, channel coding, and modulation, just to name a few. Common physical layer algorithms have been derived based on the simplifying assumptions such as linear system model, Additive White Gaussian Noise (AWGN) channel, etc. By exploiting AI/ML methods, an optimal algorithm can be developed for more practical system assumptions such as nonlinearity, and fading channels, etc.

It is also expected that, depending on the use cases, the improvements can be not only on the system performance such as throughput, spectral efficiency, and latency but also on the complexity, reliability, and overhead, etc. Moreover, the optimization can be done not only in a piecewise manner for a given transmitter/receiver processing function but also in an end-to-end manner including the entire transmitter/receiver processing chains. Therefore, it is expected that the scope of AI/ML application in the cellular system will be continuously expanded.

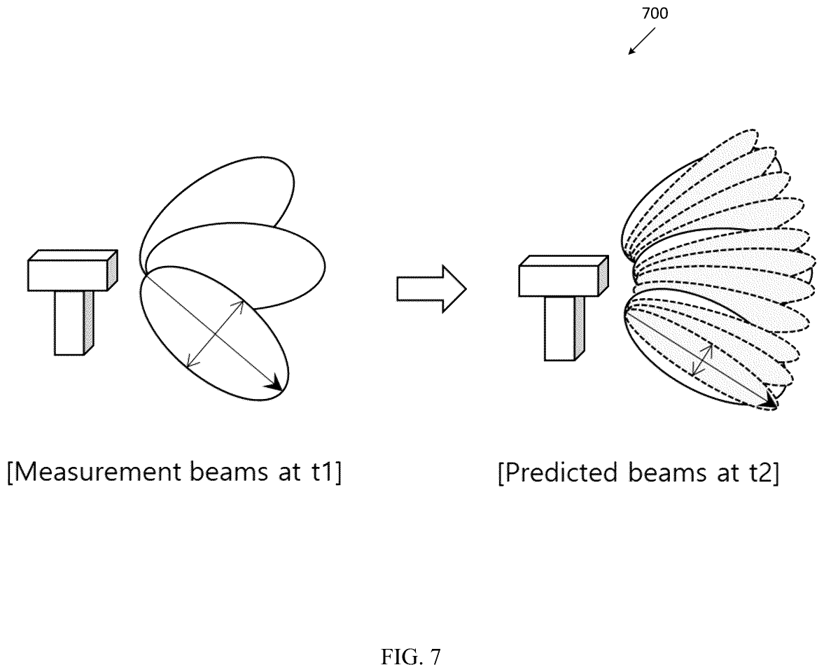

FIG. 7 illustrates a diagram 700 of an example beam prediction based on measurements of wide beams according to embodiments of the present disclosure. For example, diagram 700 illustrates beams of a gNB, such as gNB 102, for measurement by a UE, such as any of the UEs 111-116 of FIG. 1, and prediction by the UE and or gNB. This example is for illustration only and other embodiments can be used without departing from the scope of the present disclosure.

With reference to FIG. 7, spatial and/or temporal domain prediction on the best N transmission beam(s) from a cell/TRP, including the serving cell/TRP and a neighboring cell/TRP, based on a measurement on wide beams, which can be done in conjunction with the prediction on the best paired receiver beam at a UE, is discussed. A UE measures a set of wide beams at time t1 and predicts one or multiple strongest downlink transmission beams from a set of narrow beams at time t2. The downlink transmission beam predictions can be jointly performed with the downlink reception beam prediction at the UE, i.e., predictions on transmission and reception beam pairs. Alternatively, the UE measures a set of wide beams at time t1 and sends measurement report to the serving cell such that the serving cell can perform the beam prediction. The prediction can be performed in spatial domain, in temporal domain or both in spatial and temporal domains. The prediction can be performed for the same instance when the measurement is performed or for one or multiple future instances, i.e., t1≤t2.

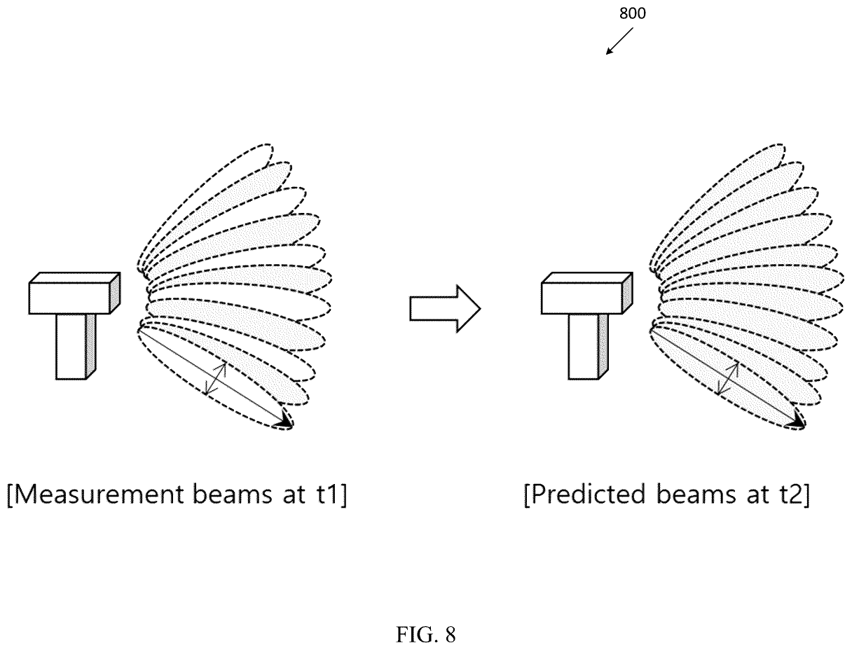

FIG. 8 illustrates a diagram 800 of an example beam prediction based on measurements of sparse beams according to embodiments of the present disclosure. For example, diagram 800 illustrates beams of a gNB, such as gNB 102, for measurement by a UE, such as any of the UEs 111-116 of FIG. 1, and prediction by the UE and or gNB. This example is for illustration only and other embodiments can be used without departing from the scope of the present disclosure.

With reference to FIG. 8, spatial and/or temporal domain prediction on the best N transmission beams from a cell/TRP, including the serving cell/TRP and a neighboring cell/TRP, based on measurements on sparse beams, which can be done in conjunction with the prediction on the best paired receiver beam at a UE, is discussed. A UE measures a set of sparse beams at time t1 and predicts one or multiple strongest beams from a set of dense beams at time t2. Alternatively, the UE measures a set of sparse beams at time t1 and sends measurement report to the serving cell such that the serving cell can perform the beam prediction. The prediction can be performed in spatial domain, in temporal domain or both in spatial and temporal domains. The prediction can be performed for the same instance when the measurement is performed or for one or multiple future instance, i.e., t1≤t2.

With intelligent beam prediction, the beam sweeping overhead can be reduced in both spatial and temporal domains, i.e., via wide/sparse beams for measurements with less frequent measurement occasions.

The beam prediction can be done either using AI/ML-based method or non-AI/ML-based method such as using advanced signal processing techniques based on filtering, e.g., particle filter or extended Kalman filter, etc. The beam prediction can be performed on the transmission beam used by the cell/TRP, on the receive beam used by the UE, or both on the transmission and receive beam pairs.

The choice of a proper beam prediction model can be dependent on the UE's channel environment and/or geographical location. Therefore, there is a need to define a set of signaling between the network and the UE regarding the UE's channel environment and/or geographical location to assist beam prediction model selection either at the UE or at the network.

Embodiments of the present disclosure recognize, when the beam prediction is performed at the UE, there is a need to define procedures and set of signaling for UEs to perform beam prediction and send the measurement report.

Embodiments of the present disclosure further recognize, when the beam prediction is performed at the network, there is a need to define procedures and set of signaling for UEs to send the assistance information to the serving cell such that the beam prediction can be performed at the network.

Embodiments of the present disclosure further recognize, when the beam prediction is performed either at the UE or at the network, the beam measurement report may include reports on more than one beams and/or more than one instances. Therefore, there is a need to enhance the beam measurement report to reduce the feedback overhead.

The performance of the currently used beam prediction model may degrade over time as the UE's channel environment and/or geographical location changes. Therefore, there is a need to define a set of signaling between the network and the UE to exchange information regarding the effectiveness of the currently used beam prediction model to perform model switching, update, or fallback, if necessary.

With prediction based beam management, the occurrence of future beam failure event can be early detected. Therefore, there is a need to define procedures to perform beam failure recovery (BFR) in a proactive manner.

The present disclosure relates to a communication system.

The present disclosure relates to defining functionalities and procedures to support prediction based beam management in cellular systems.

The present disclosure further relates to indicating UE's channel environment and/or geographical location to assist beam prediction model selection either at the UE or at the network.

The present disclosure also relates to defining procedures and set of signaling for UE to perform beam prediction and send the report including predicted one or more best beam indexes with or without associated predicted or actual measurement quantities, when the prediction is performed at the UE, and for UE to send the assistance information including such as measurement quantities to the serving cell when the prediction is performed at the network.

The present disclosure further relates to enhancing beam measurement report when the report includes reports on more than one beams and/or more than one instances.

The present disclosure also relates to defining a set of signaling between the network and the UE to exchange information regarding the effectiveness of the currently used beam prediction model for model switching, update, or fallback, if necessary.

The present disclosure further relates to defining procedures to perform early detection of future beam failure event and BFR in a proactive manner.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the present disclosure that changes in the embodiments and examples shown may be made without departing from the scope of the present disclosure.

The flowcharts herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Embodiments of the present disclosure for prediction based beam management in cellular systems are fully elaborated further herein.
Method and apparatus for indicating a UE's channel environment and/or geographical location to assist beam prediction model selection either at the UE 116 or at the network 130.
Method and apparatus for procedures and signaling for a UE to perform beam prediction and send the report, including predicted one or more best beam indexes with or without associated predicted or actual measurement quantities, when the prediction is performed at the UE 116, and for the UE 116 to send the assistance information including such as measurement quantities to the serving cell when the prediction is performed at the network 130.
Method and apparatus for reporting beam measurement when the report includes reports on more than one beams and/or more than one instances.
Method and apparatus for signaling between the network 130 and the UE 116 to exchange information regarding the effectiveness of the currently used beam prediction model.
Method and apparatus for procedures to perform early detection of future beam failure event and BFR in a proactive manner.

A detailed description of systems and methods consistent with embodiments of the present disclosure is provided herein. While several embodiments are described, it should be understood that the present disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the present disclosure.

The beam prediction can be performed at a UE, at a network, or at both. When the prediction is performed at a UE, the UE 116 sends beam prediction report containing one or multiple strongest predicted beams for one or multiple instances with or without associated predicted or actual measurement quantities. The network may adjust a downlink transmission beam from a cell/TRP to the UE based on the beam prediction report from the UE. When the prediction is performed at the network 130, the UE 116 sends beam measurement report on one or multiple strongest measured beams along with assistance information for network to perform prediction.

When the beam prediction is performed at a UE, the UE 116 may have multiple beam prediction models, either AI/ML-based or non-AI/ML-based, designed/trained for specific scenarios and/or environments. In this case, the serving cell provides assistance information to the UE 116 to help the UE 116 to select or switch to a proper beam prediction model. Alternatively, the models supported by the UE 116 is reported to the serving cell, which can be in terms of model ID with associated information and/or model functionality. The network 130 indicates to the UE 116 a proper model to be used by the UE 116 based on the assistance information provided by the UE 116. Further alternatively, the UE 116 selects or switches to a proper beam prediction model by itself based on local information available at the UE.

When the beam prediction is performed at a network, the network 130 may have multiple beam prediction models, either AWL-based or non-AWL-based, designed/trained for specific scenarios and/or environments. In this case, a UE provides assistance information to the serving cell to assist the serving cell to select or switch to a proper beam prediction model.

Herein are examples of assistance information for a proper beam prediction model selection or switch, which can be provided either by the UE 116 to the network 130 if the beam prediction is performed at the network 130 or provided by the network 130 to the UE 116 if the beam prediction is performed at the UE 116.

In one example, the UE 116 provides the channel environment perceived by the UE 116 to the serving cell and/or the network 130 provides the channel environment of the UE 116 perceived by the serving cell, e.g., based on UL reference signal measurement, to the UE 116, such as urban microcells (UMa)/urban microcells (UMi)/indoor hotspot (InH)/rural, clutter/blockage presence/density/severity, LOS/NLOS indication, indoor/outdoor indication, in-car indication, in-building indication, mobility in terms of velocity or categorization of speeds, e.g., pedestrian/vehicle/high-speed train, etc.

In another example, the UE 116 provides to the serving cell, or the serving cell provides to the UE 116, the Doppler profile measured on the channel between the UE 116 and the serving cell, which may include Doppler spread, Doppler shift, relative Doppler shift.

In yet another example, the UE 116 provides to the serving cell, or the serving cell provides to the UE 116, the multipath profile measured on the channel between the UE 116 and the serving cell, which may include delay spread, per-path weight, delay, and/or Doppler value per each signal propagation path. If the UE 116 provides the multipath profile to the serving cell, the UE 116 may be provided by the serving cell a threshold for signal strength such that the weight, delay, and/or Doppler values are reported to the serving cell for path(s) whose strength is greater than the threshold. The strength can be expressed in terms of amplitude or power of the signal. The strength can be measured by averaging the values over the subcarriers and/or symbols carrying reference signals or taken as the maximum values over the subcarriers and/or symbols carrying reference signals.

In yet another example, the UE 116 provides to the serving cell, or the serving cell provides to the UE 116, the UE 116's geographical location and/or scenario, which may be in terms of zone ID or scenario ID from a set of predefined scenarios. The definition of zones and the corresponding zone IDs can be provided by the serving cell to the UE 116. A zone may be comprised of one or multiple cells. If a zone includes a single cell, then the zone ID may coincide with cell ID. If a zone includes one or multiple cells, the zone ID may coincide with tracking area ID.

In yet another example, a serving cell area is divided into multiple zones and assigned with unique ID within the cell. A set of scenarios can be defined and signaled to the UE 116. It can be, for example, UMa/UMi/InH/rural scenarios, high/low clutter/blockage scenarios, LOS/NLOS scenarios, indoor/outdoor scenarios, in-car scenarios, in-building scenarios, pedestrian/vehicle/high-speed train scenarios, etc.

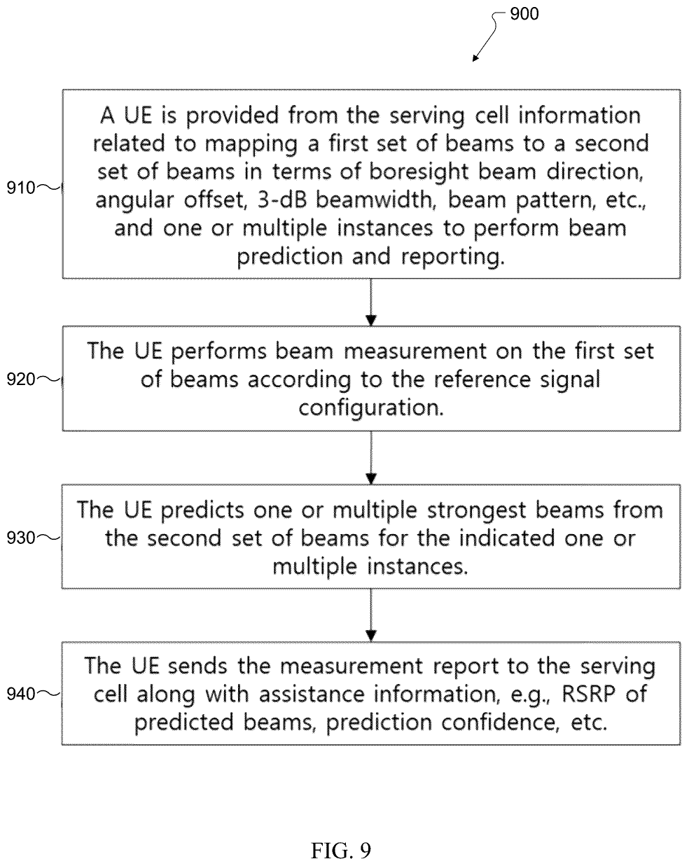

FIG. 9 illustrates a flowchart 900 of an example UE procedure for spatial/temporal domain beam prediction according to embodiments of the present disclosure. For example, flowchart 900 of an example UE procedure for spatial/temporal domain beam prediction can be performed by any of the UEs 111-116 of FIG. 1, and a corresponding procedure can be performed by any of the B Ss 101-103 of FIG. 1. This example is for illustration only and other embodiments can be used without departing from the scope of the present disclosure.

The procedure begins with 910, a UE is provided from the serving cell information related to mapping a first set of beams to a second set of beams in terms of boresight beam direction, angular offset, 3-dB beamwidth, beam pattern, amplitude/power of the beam, etc. In one example, as illustrated in FIG. 7, the first set of beams may have wide beamwidth than the second set of beams. One wide beam in the first set can be mapped to multiple narrow beams in the second set. The serving cell informs the UE 116 on how many narrow beams in the second set are associated with a beam in the first set and their mapping relationship, e.g., in terms of angular offset, 3-dB beamwidth, beam pattern, amplitude/power of the beam, etc., with respect to the beam in the first set. In another example, as illustrated in FIG. 8, the first set of beams may be sparse than the second set of beams, e.g., the first set of beams is a subset of the second set of beams. One beam in the first set can be mapped to multiple adjacent beams of the same characteristics, e.g., in terms of 3-dB beamwidth, etc., in the second set. The serving cell informs the UE 116 on how many beams in the second set are associated with a beam in the first set and their mapping relationship, e.g., in terms of angular offset, etc., with respect to the beam in the first set. In yet another example, the first and the second set of beams may be identical. In this case, the second set of beams is not explicitly signaled to the UE, and it is implicitly assumed by the UE that the second set of beams is identical with the first set of beams.

In 910, the UE 116 is also provided from the serving cell one or multiple instances to perform beam prediction and reporting. The one or multiple instances may include the instance in which the beam measurement resource is configured for the first set of beams. The one or multiple instances may also include future instances later than when the beam measurement is performed. In one example, a UE can be indicated by the serving cell the beam prediction window for which the UE 116 predicts future reference signal received power (RSRP)/reference signal received quality (RSRQ)/signal to interference and noise ratio (SINR) of the beams and, consequently, best-N beams from the second set of beams. The beam prediction window can be indicated to the UE 116 with duration and offset from the reference resource for the measurement of the first set of beams, e.g., {n_{ref}+o, . . . , n_{ref}+o+Wₚ}, where Wₚ is the prediction window duration and o is the prediction start offset from the reference resource at n_{ref}. Both Wₚ and o can take zero or positive integer values, e.g., in a number of slots, subframes, symbols or ms. Similarly, the prediction window can be indicated to the UE 116 with duration and offset relative to the beam measurement report instance, e.g., {nᵣₑₚ+o, . . . , nᵣₑₚ+o+Wₚ}, where n rep is beam measurement report instance. In this case, the offset can take any integer value including negative values, while the window can take zero or positive integer values, e.g., in a number of slots, subframes, symbols or ms. In another example, the UE 116 can be indicated by the serving cell the prediction start offset o, the prediction interval I, and the number of instances for prediction K. Accordingly, the UE 116 will predict the beams from the second set of beams for a set of instances {n_{ref}+o, n_{ref}+o+I, n_{ref}+o+2·I, . . . , n_{ref}+o+(K−1)·I}, where o, I, and K are indicated to the UE in a number of slots, subframes, symbols or ms. Similarly, the start offset can be indicated relative to the beam measurement report instance nᵣₑₚ. Alternatively, the UE 116 can be indicated by the network 130 a set of offset values indicating future instances for beam prediction. For instance, the network 130 can indicate a set of offset values, e.g., {o₁, o₂, o₃}, to the UE 116, and the UE 116 is to predict the beams for {n_{ref}+o₁, n_{ref}+o₂, n_{ref}+o₃}, where o₁, o₂, and o₃ are indicated to the UE in a number of slots, subframes, symbols or ms. Similarly, the start offset can be indicated relative to the beam measurement report instance nᵣₑₚ.

In 920, the UE 116 then performs beam measurement on the first set of beams according to the reference signal configuration. In 930, based on the measurements on the first set of beams, the UE 116 then predicts one or multiple strongest beams from the second set of beams for the indicated one or multiple instances. The UE 116 may perform beam prediction either using AWL-based or non-AUML-based model, which may be indicated by the serving cell using model ID or may be up to UE implementation.

In 940, the UE 116 then sends the measurement report to the serving cell along with assistance information. The measurement report includes one or multiple strongest beam indices from the second set of beams, possibly including their RSRP/RSRQ/SINR values for one or multiple instances indicated by the serving cell. Examples of the possible assistance information are herein:
Probability of n-th strongest predicted beam to be within N actual strongest beams at the predicted future instance.
Early beam failure indication, e.g., probability of beam failure at the predicted future instance.
Indication on the requirement of more/less resources for beam measurement, i.e., more/less spatial beam sweeping, to perform prediction.
Indication on the requirement of larger/smaller number of transmission beam repetition(s) for UE receiver beam prediction.
Favorable or preferred angular range of beam directions or directivity for the beam measurement reference signal configuration.
Favorable or preferred temporal frequency of beam measurement reference signals.
UE channel environment, e.g., UMa/UMi/InH/rural, clutter/blockage presence/density/severity, line-of-sight (LOS)/non-line-of-sight (NLOS) indication, indoor/outdoor indication, in-car indication, in-building indication, mobility in terms of velocity or categorization of speeds, e.g., pedestrian/vehicle/high-speed train, etc.

Based on the above assistance information, the network determines its downlink transmission beam, uplink reception beam, RS configuration for beam measurements, or model for beam prediction at the network or at the UE.

When the UE 116 sends beam measurement report to the serving cell including reports on more than one beams or, equivalently, beam measurement resources, the RSRP/RSRQ/SINR values of the strongest beam is reported and the difference in RSRP/RSRQ/SINR, i.e., differential RSRP/RSRQ/SINR, from the strongest beam is reported for the rest of beams. Alternatively, the differential RSRP/RSRQ/SINR can be calculated from the next stronger beam, i.e., differential RSRP/RSRQ/SINR of n+1-th strongest beam from n-th strongest beam.

When the UE 116 sends beam measurement report to the serving cell including reports on more than one instance or, equivalently, beam measurement resources, the RSRP/RSRQ/SINR values of the beam in the first instance is reported and the differential RSRP/RSRQ/SINR from the first instance or the previous instance, i.e., k-th instance for reporting k+1-th instance, is reported for the rest of instances. In this case, the differential RSRP/RSRQ/SINR can take positive or negative values. For example, the sign of differential RSRP/RSRQ/SINR can be indicated via Boolean indication. Alternatively, multiple reporting instances are ordered in terms of the RSRP/RSRQ/SINR value, and the RSRP/RSRQ/SINR of the strongest instance is reported along with the index indicating the reporting instance, i.e., a timestamp, and the differential RSRP/RSRQ/SINR from the strongest instance or the next stronger instance, i.e., differential RSRP/RSRQ/SINR of n+1-th strongest instance from n-th strongest instance, is reported for the rest of instances along with the index indicating the reporting instance. When each reporting instance includes more than one beam, for non-strongest beams, differential RSRP/RSRQ/SINR can be reported from the strongest RSRP/RSRQ/SINR within the instance or strongest RSRP/RSRQ/SINR of the first reported instance, where the first reported instance can be the earliest instance in time or the instance containing strongest RSRP/RSRQ/SINR value.

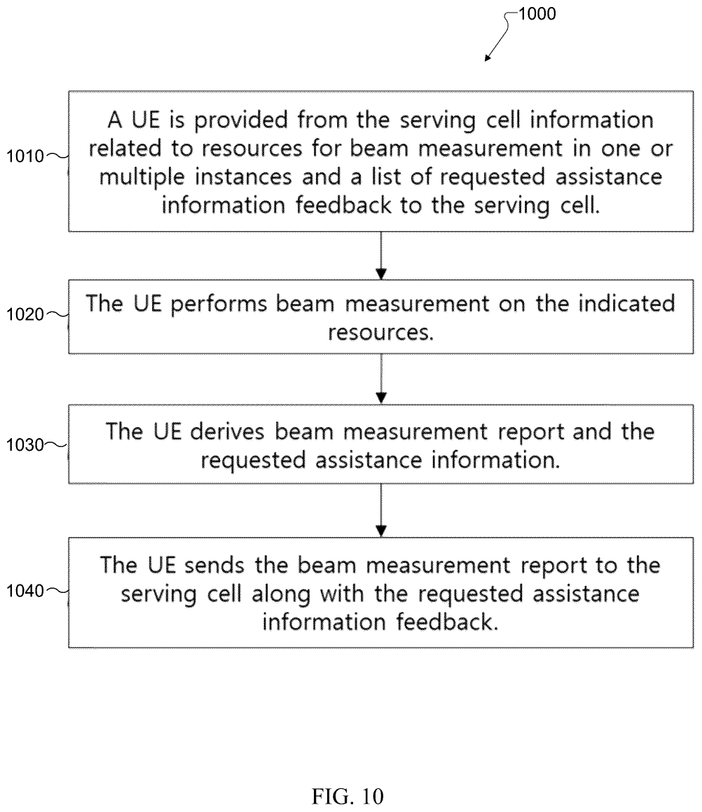

FIG. 10 illustrates a flowchart 1000 of an example UE procedure for sending assistance information to a serving cell for performing beam prediction according to embodiments of the present disclosure. For example, flowchart 1000 of an example UE procedure for sending assistance information to a serving cell for performing beam prediction can be performed by the UE 116 of FIG. 3, and a corresponding procedure can be performed by the BS 102 of FIG. 2. This example is for illustration only and other embodiments can be used without departing from the scope of the present disclosure.

The procedure begins in 1010, a UE is provided from the serving cell information related to resources for beam measurement in one or multiple instances and a list of requested assistance information feedback to the serving cell. Examples of the possible assistance information that can be requested by the serving cell to the UE 116 are herein:
UE channel environment including environmental scenario, Doppler profile, multipath profile, geographical location related information, etc., as described herein. The UE 116 may be also signaled by the serving cell a threshold value on the UE 116's environmental change, e.g., speed, Doppler shift, delay spread, etc., such that the UE 116 sends the assistance information on the UE 116 channel environment if a condition is met, i.e., greater or smaller than the threshold. The UE 116 may be indicated by the serving cell to send the assistance information on the UE 116 channel environment if the UE 116's location deviates more than a certain distance, e.g., in meters, from the UE 116's current location. If the distance between the UE 116 and a reference point, e.g., serving cell/TRP location, becomes greater than a certain distance or greater than a certain distance from the current distance, the distance between the UE 116 and another reference point, e.g., neighboring cell/TRP location, becomes smaller than a certain distance or smaller than a certain distance from the current distance.
Probability of the current n-th strongest beam to remain as N strongest beams in T slots later, where n, N, T are indicated by the serving cell to the UE 116. The UE 116 may be also signaled by the serving cell a threshold value such that the UE 116 sends the corresponding information if the estimated probability meets a condition, i.e., greater or smaller than the threshold.
Early beam failure indication, e.g., probability of beam failure if the UE 116 stays with the current gNB Tx beam in T slots later, where T is indicated by the serving cell to the UE 116. The UE 116 may also be signaled by the serving cell a threshold value such that the UE 116 sends the corresponding information if the estimated probability meets a condition, i.e., greater or smaller than the threshold.
The current value of BFI_COUNTER or the statistics, such as mean, median, maximum, minimum, variance, standard deviation, etc. The UE 116 may be signaled by the serving cell a threshold value on the current value or any statistics of BFI_COUNTER such that the UE 116 sends corresponding information if a condition is met, i.e., greater or smaller than the threshold.

In 1020, the UE 116 then performs beam measurement on the indicated resources. In 1030, the UE 116 then derives beam measurement report and the requested assistance information. As described, the UE 116 can be provided from the serving cell information related to resources for beam measurement in one or multiple different time instances. If the UE 116 is signaled on beam measurement resources in more than one instance, the UE 116 can be also signaled to send the beam measurement report on the signaled instances or the latest instance only. If the UE 116 sends a beam measurement report on multiple instances, the measurement report can be enhanced via differential RSRP/RSRQ/SINR feedback as described herein. If the beam measurement report includes the report on the latest instance only, the beam measurement resources in multiple instances can be used by the UE 116 to derive assistance information as described herein to assist the serving cell to perform the prediction. The UE 116 can utilize the previous beam measurements to derive the assistance information if the UE 116 is not configured with beam measurement resources in multiple instances for the current report.

In 1040, the UE 116 then sends the beam measurement report to the serving cell along with the requested assistance information feedback. Based on the beam measurement report and assistance information provided by the UE 116, the serving cell perform beam prediction in spatial, temporal, or both spatial and temporal domains.

In UE-side prediction, as described in FIG. 9, the UE 116 is indicated by the serving cell metrics to monitor the performance of currently used beam prediction model, either AWL-based or non-AWL-based. With the performance monitoring report provided by the UE 116, the serving cell may indicate to the UE 116 to perform model switching, e.g., by indicating model ID, to update or finetune the model with the indication on the dataset or to fallback to a default non-prediction based method. In network-side prediction, as described in FIG. 10, the UE 116 is indicated by the serving cell to send the feedback related to the performance monitoring of currently used beam prediction model at the network 130. The network 130 may decide to switch, update, or fallback its beam prediction model based on the UE 116 feedback on the beam prediction performance monitoring. The network 130 may also request the UE 116 to provide a dataset for the network 130 to retrain or finetune its beam prediction model.

Examples of possible metrics that can be indicated by the serving cell to the UE 116 for performance monitoring and feedback, either for UE-side or network-side predictions, are as follows:
The current value of BFI_COUNTER or the statistics as described herein. The UE 116 may be signaled, by the serving cell, a threshold value such that the UE 116 sends corresponding information if a condition is met.
Early beam failure indication as described herein.
Virtual BFR if the UE 116 remains with a certain beam, e.g., the previous, current or any beam that is indicated by the serving cell, etc. The UE 116 runs BFI_COUNTER as if the UE 116 is served by the indicated beam and sends the virtual BFR if BFI_COUNTER exceeds a certain threshold value indicated by the serving cell which may be the same or different from beamFailureInstanceMaxCount signaled for the actual BFR. It can be an early indication on the occurrence of virtual beam failure in a future instance. The UE 116 may also provide the serving cell the information on the future instance at which the virtual beam failure is expected to occur.
RSRP/RSRQ/SINR of the currently associated beam, previously associated beam, previously predicted beams, or any specific beam indicated by the serving cell.
RSRP/RSRQ/SINR difference between the best predicted beam and the best actual beam; average RSRP/RSRQ/SINR difference between N best predicted beam and N actual best beam, which can be also a weighted average; and/or RSRP/RSRQ/SINR difference between the best predicted beam and the best predicted beam's actual RSRP/RSRQ/SINR.
PDCCH/physical downlink shared channel (PDSCH) decoding error rate.
Statistics on the accuracy and/or confidence of previously predicted beams: Probability or average of the number of beams among N previously predicted beams to be actual N strongest beams; probability of the previously predicted best beam to be the actual best beam; probability of the previously predicted best beam to be one of N actual strongest beams; and/or probability of N strongest predicted beams to include the actual best beam.

Based on the above performance monitoring report from a UE, the network determines its downlink transmission beam, uplink reception beam, RS configuration for beam measurements, or perform model selection, switching, or fallback.

A UE can predict the probability of future beam failure and inform the serving cell. The serving cell may provide a threshold value such that the UE 116 sends the early BFR indication if the predicted probability is greater than the indicated threshold. If the predicted probability of future beam failure is greater than another threshold value that may be indicated by the serving cell, the UE 116 can initiate proactive beam change procedure towards a new candidate beam. If a contention-free-random-access (CFRA) resource is configured for the new candidate beam, the UE 116 can start the random-access procedure by transmitting random access channel (RACH) preamble on the configured resource. If CFRA resource is not configured for the new candidate beam, the UE 116 can indicate to the serving cell to request to configure CFRA resource for the new candidate beam along with early BFR indication. The UE 116 may also start contention-based-random-access. The proactive beam change procedure may be initiated by the serving cell by providing PRACH preamble resources to the UE, which can be signaled, e.g., via a PDCCH providing DCI format 1_0. The ‘Frequency Domain Resource Assignment’ field may indicate all ‘1’s indicating that the DCI is being used to initiate a PDCCH Order.

For early BFR, in one example, the serving cell can provide the UE 116 with a RSRP threshold and beamFailureInstanceMaxCount for the purpose of early BFR, which may be the same or different from the values indicated for actual BFR. The BFI is triggered from L1 to L2 if the RSRP of the serving beam falls below the configured RSRP threshold for early BFR. When the BFI_COUNTER for early BFR reaches beamFailureInstanceMaxCount indicated for early BFR, the UE 116 sends early BFR indication. The early BFR indication may include a request on CFRA resource configuration for a new candidate beam if it is not currently configured. In another example, the UE 116 can be indicated, by the serving cell, the RSRP and likelihood (or probability) threshold values for early BFR. If the likelihood of the RSRP of the current serving beam to fall below the indicated RSRP threshold is greater than the indicated likelihood threshold value, early BFR is declared, and the UE 116 sends the indication to the serving cell. The early BFR indication may include a time stamp on when the BFR is expected to occur in the future.

When the early BFR is declared, the UE 116 sends the report to the serving cell including the indication on the occurrence of early BFR along with other information such as current/future BFI_COUNTER statistics, current RSRP and predicted future RSRP of the serving beam, the best N candidate beams via beam ID or measurement resource ID, the current and predicted future RSRP of the candidate beams, etc. Upon receiving the early BFR indication, the network 130 can send the confirmation to the UE 116 for starting the beam change procedure and may configure CFRA resource along with indication on the corresponding beam index via beam ID or measurement resource ID, if CFRA resource is not currently configured for the corresponding beam. The serving cell can provide PRACH preamble resources to the UE, which can be signaled, e.g., via a PDCCH providing DCI format 1_0. The ‘Frequency Domain Resource Assignment’ field may indicate all ‘1’ s indicating that the DCI is being used to initiate a PDCCH Order.

In the case of network-side beam prediction, the serving cell can indicate to the UE 116 to perform the beam change procedure along with the target candidate beam index and CFRA resource configuration, if not currently configured, upon detection of the future beam failure event. The serving cell can provide PRACH preamble resources to the UE, which can be signaled, e.g., via a PDCCH providing DCI format 1_0. The ‘Frequency Domain Resource Assignment’ field may indicate all ‘1’ s indicating that the DCI is being used to initiate a PDCCH Order.

Any of the various embodiments can be utilized independently or in combination with at least one other variation embodiment. The flowcharts herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE) to report information related to a beam prediction, the method comprising:
receiving:
first information related to reception of reference signals (RSs) for beam measurements,
second information indicating one or more reporting quantities related to the beam prediction,
third information related to determining the one or more reporting quantities,
fourth information related to transmitting the one or more reporting quantities, and
the RSs for the beam measurements based on the first information;
measuring the RSs;
determining the one or more reporting quantities indicated by the second information based on the third information and the measurement of RSs; and
transmitting a channel with the one or more reporting quantities based on the fourth information.

2. The method of claim 1, wherein:
the one or more reporting quantities indicated by the second information are related to predicting (i) one or more downlink transmission beams or (ii) one or more downlink transmission and reception beam pairs, and
the one or more reporting quantities includes one or more:
indexes of (i) the predicted one or more downlink transmission beams or (ii) the predicted one or more downlink transmission and reception beam pairs,
predicted physical layer measurement quantities,
actual physical layer measurement quantities, or
parameters related to a confidence of (i) the predicted one or more downlink transmission beams or (ii) the predicted one or more downlink transmission and reception beam pairs.

3. The method of claim 1, wherein the third information includes:
first parameters indicating a first set of beams,
second parameters indicating a second set of beams, and
third parameters indicating a relationship between the first and second sets of beams.

4. The method of claim 1, wherein:
the third information includes parameters indicating one or more time instances for which the one or more reporting quantities are determined, and
transmitting the channel with the one or more reporting quantities further comprises transmitting the channel with the one or more reporting quantities determined for the one or more time instances.

5. The method of claim 1, wherein:
the one or more reporting quantities indicated by the second information are related to performance monitoring of the beam prediction, and
the one or more reporting quantities includes at least one of:
quantities related to accuracy of the beam prediction,
quantities related to beam failure,
predicted physical layer measurement quantities of one or more predicted beams,
actual physical layer measurement quantities of the one or more predicted beams, and
quantities based on the predicted and actual physical layer measurement quantities of the one or more predicted beams.

6. The method of claim 1, wherein:
transmitting the channel further comprises transmitting the channel with information related to updating the RSs for the beam measurements, and
the information indicates at least one of:
a preferred direction or directivity of RS transmissions,
a preferred number of repetitions of the RS transmissions, and
a preferred temporal frequency of the RS transmissions.

7. The method of claim 1, wherein transmitting the channel further comprises transmitting the channel with information related to a UE location or channel environment.

8. A user equipment (UE) comprising:
a transceiver configured to receive:
first information related to reception of reference signals (RSs) for beam measurements,
second information indicating one or more reporting quantities related to a beam prediction,
third information related to determining the one or more reporting quantities,
fourth information related to transmitting the one or more reporting quantities, and
the RSs for the beam measurements based on the first information; and
a processor operably coupled to the transceiver, the processor configured to:
measure the RSs; and
determine the one or more reporting quantities indicated by the second information based on the third information and the measurement of RSs,
wherein the transceiver is further configured to transmit a channel with the one or more reporting quantities based on the fourth information.

9. The UE of claim 8, wherein:
the one or more reporting quantities indicated by the second information are related to predicting (i) one or more downlink transmission beams or (ii) one or more downlink transmission and reception beam pairs, and
the one or more reporting quantities includes one or more:
indexes of (i) the predicted one or more downlink transmission beams or (ii) the predicted one or more downlink transmission and reception beam pairs,
predicted physical layer measurement quantities,
actual physical layer measurement quantities, or
parameters related to a confidence of (i) the predicted one or more downlink transmission beams or (ii) the predicted one or more downlink transmission and reception beam pairs.

10. The UE of claim 8, wherein the third information includes:
first parameters indicating a first set of beams,
second parameters indicating a second set of beams, and
third parameters indicating a relationship between the first and second sets of beams.

11. The UE of claim 8, wherein:
the third information includes parameters indicating one or more time instances for which the one or more reporting quantities are determined, and
the transceiver is further configured to transmit the channel with the one or more reporting quantities determined for the one or more time instances.

12. The UE of claim 8, wherein:
the one or more reporting quantities indicated by the second information are related to performance monitoring of the beam prediction, and
the one or more reporting quantities includes at least one of:
quantities related to accuracy of the beam prediction,
quantities related to beam failure,
predicted physical layer measurement quantities of one or more predicted beams,
actual physical layer measurement quantities of the one or more predicted beams, and
quantities based on the predicted and actual physical layer measurement quantities of the one or more predicted beams.

13. The UE of claim 8, wherein:
the transceiver is further configured to transmit the channel with information related to updating the RSs for the beam measurements, and
the information indicates at least one of:
a preferred direction or directivity of RS transmissions,
a preferred number of repetitions of the RS transmissions, and
a preferred temporal frequency of the RS transmissions.

14. The UE of claim 8, wherein the transceiver is further configured to transmit the channel with information related to a UE location or channel environment.

15. A base station (BS) comprising:
a transceiver configured to:
transmit:
first information related to reception of reference signals (RSs) for beam measurements,
second information indicating one or more reporting quantities related to a beam prediction,
third information related to determining the one or more reporting quantities,
fourth information related to transmitting the one or more reporting quantities, and
the RSs for the beam measurements based on the first information; and
receive, based on the fourth information, a channel with the one or more reporting quantities that are based on the third information and the RSs.

16. The BS of claim 15, wherein:
the one or more reporting quantities indicated by the second information are related to predicting (i) one or more downlink transmission beams or (ii) one or more downlink transmission and reception beam pairs, and
the one or more reporting quantities includes one or more:
indexes of (i) the predicted one or more downlink transmission beams or (ii) the predicted one or more downlink transmission and reception beam pairs,
predicted physical layer measurement quantities,
actual physical layer measurement quantities, or
parameters related to a confidence of (i) the predicted one or more downlink transmission beams or (ii) the predicted one or more downlink transmission and reception beam pairs.

17. The BS of claim 15, wherein the third information includes:
first parameters indicating a first set of beams,
second parameters indicating a second set of beams, and
third parameters indicating a relationship between the first and second sets of beams.

18. The BS of claim 15, wherein:
the third information includes parameters indicating one or more time instances for which the one or more reporting quantities are determined, and
the transceiver is further configured to receive the channel with the one or more reporting quantities determined for the one or more time instances.

19. The BS of claim 15, wherein:
the one or more reporting quantities indicated by the second information are related to performance monitoring of the beam prediction, and
the one or more reporting quantities includes at least one of:
quantities related to accuracy of the beam prediction,
quantities related to beam failure,
predicted physical layer measurement quantities of one or more predicted beams,
actual physical layer measurement quantities of the one or more predicted beams, and
quantities based on the predicted and actual physical layer measurement quantities of the one or more predicted beams.

20. The BS of claim 15, wherein:
the transceiver is further configured to receive the channel with information related to updating the RSs for the beam measurements, and
the information indicates at least one of:
a preferred direction or directivity of RS transmissions,
a preferred number of repetitions of the RS transmissions, and
a preferred temporal frequency of the RS transmissions.
